(19) United States
(12) Patent Application Publication
(10) Pub. No.: US 2010/0034389 A1
(43) Pub. Date: Feb. 11, 2010

(54) CONDITIONAL ACCESS SYSTEM AND METHOD FOR LIMITING ACCESS TO CONTENT IN BROADCASTING AND RECEIVING SYSTEMS

(75) Inventor: Oleg Veniaminovich Sakharov, St. Petersburg (RU)

Correspondence Address: WOODCOCK WASHBURN LLP, CIRA CENTRE, 12TH FLOOR, 2929 ARCH STREET, PHILADELPHIA, PA, 19104-2891, US

(73) Assignees: Oleg Veniaminovich Sakharov, St. Petersburg (RU); Nikolay Vyatcheslavovich Mikhailov, St. Petersburg (RU); Sergey Georgievich Kirikov, St. Petersburg (RU)

(21) Appl. No.: 12/530,306

(22) PCT Filed: Dec. 24, 2007
(86) PCT No.: PCT/RU07/00723

§ 371 Date: Sep. 8, 2009

(30) Foreign Application Priority Data
Mar. 13, 2007 (RU) 2007108939

(51) Int. Cl. H04L 9/32; G06F 17/30; G06F 15/16; H04L 9/00; G06F 21/00

(52) U.S. Cl. 380/277; 713/176; 707/3; 709/231; 707/E17.014; 713/184; 713/168

(57) ABSTRACT

A conditional access system and method provides conditional access by a subscriber's network terminal over a computer network to encrypted content of a content provider. The conditional access system includes a content stream adapting server that receives streams of encrypted content from the content provider, reformats the encrypted content streams using session keys into a format suitable for transmission by IP addressing, and assigns a unique IP address in the computer network to the reformatted encrypted content streams. An access control server provides access to the encrypted content streams under control of an operator of the computer network. A validating server provides the session keys to the content stream adapting server, receives from a subscriber a request for an encrypted content stream, validates the subscriber for access to the requested encrypted content stream and, upon validation of the subscriber, provides the subscriber's network terminal with the session keys for the selected encrypted content stream through a secure network channel and authorizes the access control server to provide access to the selected encrypted content stream by the network terminal of the subscriber. The content provider maintains control over distribution of the selected encrypted content stream through selective validation of subscribers at the validating server and may be paid directly for the selected content by the subscriber using a prepaid PIN code card issued by the content provider.

### CROSS-REFERENCE TO RELATED APPLICATIONS

The present application is a national phase application of PCT/RU2007/000723 filed Dec. 24, 2007, which claims priority to Russian Patent Application No. 2007108939 filed Mar. 13, 2007.

### TECHNICAL FIELD

The invention relates to broadcasting and receiving systems and systems and methods for providing conditional access to protected content of same.

### BACKGROUND OF THE INVENTION

The distribution of multimedia content (audiovisual materials) in digital formats has become widespread. Multimedia content is distributed both in the form of files and in formats based on the Digital Video Broadcasting (DVB) specification. In addition, the part of the population that may access computer networks is increasing steadily, which has increased the interest in computer systems as a promising environment for multimedia content distribution. However, the extensive implementation of multimedia content broadcasting technology in computer networks is limited by a number of constraints. The main factors are the high costs of head end stations converting the cryptographically protected format of multimedia content into new cryptographically protected formats suitable for use in a computer network. On the other hand, providers of multimedia content do not always trust the operators of computer networks and, therefore, wish to have a means of subscriber control independent of the network operators, which ensures the elimination of abuses by potential content consumers.

U.S. Pat. No. 6,307,939 discloses a way to reduce the cost by adapting protected content for retransmission in another network using a conditional access system. The described method suggests not to change the type of cryptographic protection (scrambling) of the content data, but to instead modify the stream used for individual entitlement control messages (ECM) and EMM messages (according to the agreements adopted in SIMULCRYPT techniques and standardized specification ETSI TS 101 197 V1.2.1) of which a control word for a descrambler is transmitted to a subscriber terminal. However, the realization of such a method in a computer network has the obvious drawback that it suggests using methods typical for unidirectional networks of digital multimedia content transmission for control word decrypting (e.g., satellite DVB-S and cable DVB-C broadcasting). This results in the complication of subscriber terminals and increased vulnerability to abuse by forgeries of conditional assess modules and cards.

Another method of content access limitation by means of computer network control is disclosed in U.S. Pat. No. 7,188,245, where several ways of content access restriction using protocols and hardware controlling (configuring) means of a computer network are shown. Such techniques for security organization are attractive from the point of view of the network operator since all necessary components have been already included in the structure of the majority of computer networks. However, this method can not satisfy distributors of multimedia content since, on the one hand, there remains the opportunity to conceal the real number of subscribers in the reports made to the content provider, and, on the other hand, there is the opportunity of uncontrollable copying and further distribution of the content by dishonest subscribers with access to the operator's network.

Historically, the main criterion used by content providers for defining the possibility of distribution in another network has been the opportunity to control each subscriber terminal directly and independently of the network operator. The methods allowing such control for legal subscribers are described in U.S. Pat. Nos. 6,532,539; 6,898,285; 7,120,253; and 7,149,309. However, all of the methods described in these patents can not ensure the inaccessibility of content to dishonest subscribers who use well-known card-sharing technologies widely used by DVB content pirates and typical for unidirectional data transmission systems. In particular, card sharing technology enables subscribers to install software containing descramblers and request modules for a third-party card server that includes a legal conditional access module (CAM) of the content provider. This server is treated by the content provider as a legal subscriber terminal, but it can give decrypted control words in response to demands of other users. Moreover, this method for manipulating a conditional access system (CAS) in a computer network may turn out to be very convenient and become very widespread. Thus, it is understandable that multimedia content providers become concerned when considering such well-known CAS methods for the re-distribution of quality multimedia content over computer networks. Therefore, a new system providing access to content retransmitted in a computer network is needed. At the same time, the technical realization of any new system must be as simple as possible to be economically attractive for the operators of computer networks.

It is apparent that only a relatively complex approach to the task of conditional access can meet the conflicting requirements of multimedia content providers and operators of existing computer networks. Such an approach should maintain the requirements of security quality, which can be ensured by widespread conditional access systems for unidirectional communication channels (built on the basis of cryptographic protocols, such as Viaccess, Irdeto, NDS systems), and simultaneously provide the opportunity to organize conditional access on the basis of the computer network controlling and configuring using cryptographic authorization protocols and secure connection protocols (e.g., Secure Socket Layer (SSL) or IP Security (IPSec)).

EP 1525732 describes a method of interaction between the subscriber, a server for subscriber authorization, and a server of the content provider that provides high-security decisions for access to content in computer networks. However, the method involves the direct use of session keys for subscribers during the preparation (encrypting) of content for broadcasting. This is a problem for the majority of existing content providers since it requires substantial modification of the software and hardware used by them. This is caused by the fact that the method does not provide for the use of means for direct broadcasting of protected content with entitlement control messages (ECM) and EMM streams and the adaptation of the content to a computer network so as to preserve control of subscribers by the content provider.

### SUMMARY OF THE INVENTION

In order to address the aforementioned disadvantages of the existing conditional access systems, a method and a conditional access system are provided for application in computer networks to manage interactions amongst servers adapting the stream of the provider's content for conditional access by a subscriber. The conditional access system includes a Content Stream Adapting Server (CSAS), the Computer Network (CN), network terminals (NT), an Access Control Server (ACS) that controls the access of subscribers to the computer network, and a validating server that controls access by the subscriber separate from the computer network control provided by the ACS. The content provider maintains control over the validating server so to maintain some level of control over content distribution.

A broadcasting and receiving system and a system for conditional access thereto in accordance with the invention makes it possible to retransmit content protected by a content provider in a computer network and to preserve control over the subscriber by the content provider. A digital media system in the computer network includes at least one content stream adapting server (CSAS) that is used for adapting the provider content flows and for assigning IP addresses of the computer network thereto. The provider content flows from the content stream adapting servers are accessible by the subscriber via a set of network terminals (NTs) including a content player, a descrambler (decrypter) and a content request module used for controlling subscriber access to a local computer network. A validating server provides session keys to the network terminals required for protecting control words of the provider content. The session keys are used at the content stream adapting server for encrypting control words protecting the provider's content and are placed into entitlement control messages (ECMs) corresponding to the content stream.

The control of access of subscribers' network terminals to IP addresses assigned to the adapted streams of the provider's content is carried out by control and configuring means such as an access control server of a managed computer network. Reports on the access of the subscribers of the managed computer network to the IP addresses of provider content flows are analyzed by the access control server by comparing them with messages from the validating server. For example, when messages are received from the validating server indicating that a subscriber has been denied access to the content (which is requested by the subscriber according to the IP address translation of the provider content), the access control server denies access. Access is initiated by means of the message exchange procedures between the access control server, the network terminal and the validating server, and the successfully authorized access is used for transmitting the IP address of the content flow selected by the subscriber and for forming a protected communications channel between the network terminal and the validating server.

In an exemplary embodiment, the method of providing conditional access via an access control server of a computer network by a subscriber to encrypted content of a content provider in accordance with the invention includes the content stream adapting server receiving streams of encrypted content from the content provider, reformatting the encrypted content streams using session keys from the validating server into a format suitable for transmission by IP addressing, and assigning a unique IP address in the computer network to the reformatted encrypted content streams. The validating server receives from a subscriber a request for an encrypted content stream, the request including an identification of the encrypted content stream selected by the subscriber and an ID of the network terminal of the subscriber, and upon validation of the subscriber, the validating server provides the subscriber's network terminal with the session keys for the selected encrypted content stream through a secure network channel and authorizes the access control server to provide access to the selected encrypted content stream by the network terminal of the subscriber. In this fashion, the content provider maintains control over distribution of the selected encrypted content stream through selective validation of subscribers at the validating server.

The procedure for reproducing the content flow to the network terminal includes receiving by the terminal the content flow on the IP address thereof, in demultiplexing an entitlement control message therefrom, in decrypting control words by means of a session key provided by the validating server, in descrambling the content data using the control words, and in reproducing the content data by means of a player. The actual session keys are received by the network terminal upon requests via a protected communications channel in the messages of the validating server. In this case, the control of the content provider rights is provided in that the flow reproduction can be stopped by the computer network operator by denying the access of a given network terminal to the content IP address in the managed computer network on a subscriber port and on the initiative of a validating server by the failure thereof to provide a session key requested by the network terminal. Such a method provides the possibility of paying for the provided content directly to the content provider thereof by using prepaid PIN-code cards issued by the content provider.

### BRIEF DESCRIPTION OF THE DRAWINGS

The invention will be better understood by those skilled in the art by reference to the accompanying drawings, of which:

FIG. 1 schematically illustrates an embodiment of the system according to the invention.

FIG. 2 illustrates a diagram of a message exchange during the procedure of providing access to the content and content stream retransmission in accordance with the method of the invention.

FIG. 3 illustrates a diagram of a message exchange during a simplified procedure of providing access in accordance with the method of the invention.

### DETAILED DESCRIPTION OF THE INVENTION

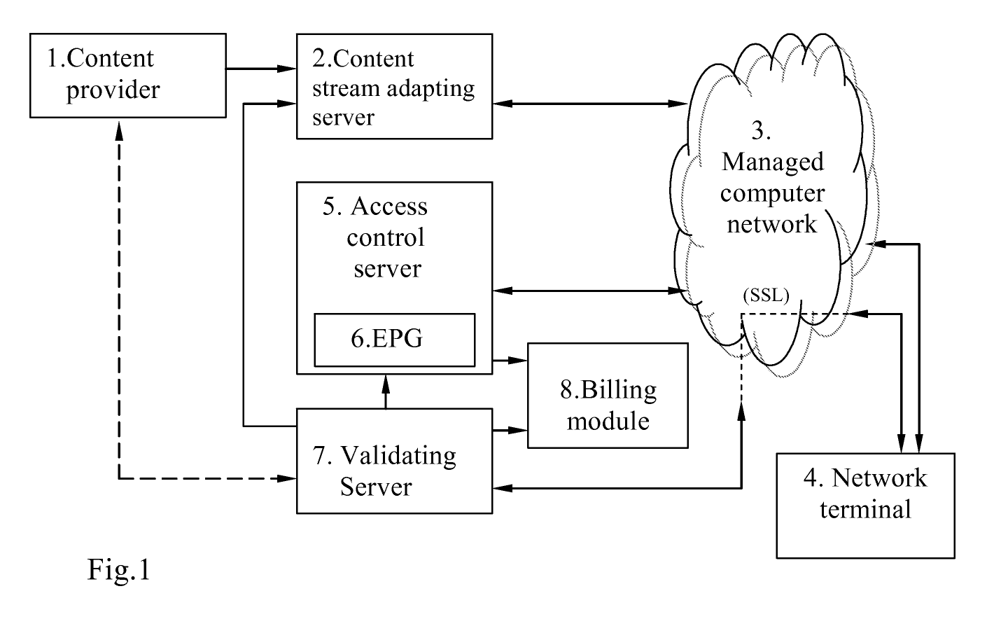

FIG. 1 schematically illustrates an embodiment of the system according to the invention. As illustrated, the system includes a content provider 1, a content stream adapting server (CSAS) 2, a managed computer network (CN) 3, one or more network terminals (NTs) 4, an access control server (ACS) 5 having an electronic program guide (EPG) 6, a validating server 7, and a billing module 8. CSAS 2 adapts the scrambled content stream from content provider 1 for retransmission in CN 3. The process of the adaptation of the protected (scrambled) provider content stream includes re-encapsulation of the content stream into a format suitable for transmission by IP addressing. In an exemplary embodiment, data blocks of the scrambled provider content stream are not modified, and control words necessary for their descrambling/decrypting are encrypted with used session keys transmitted to the CSAS 2 from the validating server 7 before being introduced into the stream of entitlement control messages (ECMs). For this purpose, the CSAS 2 removes the ECMs from encrypted content streams received from the content provider and assigns to a new stream of ECMs an IP address different from a unique IP address of basic Internet protocol assigned to a corresponding encrypted content stream. In the embodiment of FIG. 1, ACS 5 is functionally connected to an electronic program guide (EPG) module 6 and to the validating server 7, and is connected to NT 4 via a secure socket layer (SSL) of CN 3.

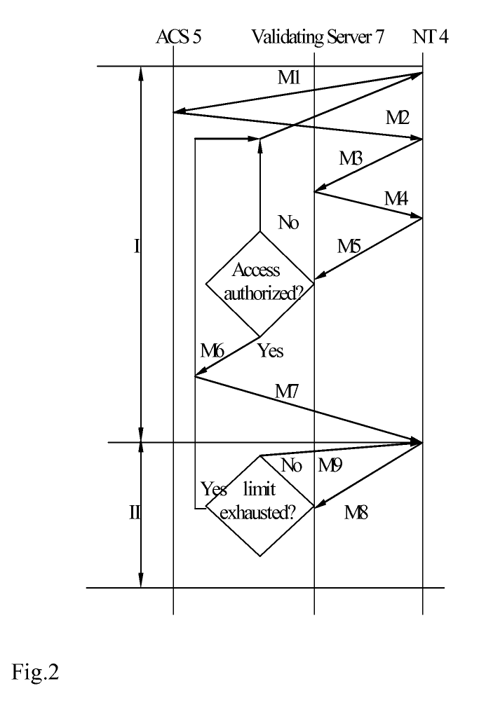

The procedure for accessing content in accordance with the invention will be described in connection with section I in FIG. 2. As illustrated, NT4 provides an inquiry (message M1) of the list of accessible streams of content from the content provider 1. The EPG module 6 answers M1 with message M2 providing a list of accessible streams of content of the provider 1. After the exchange of messages M1 and M2 with the electronic program guide (EPG) 6, NT 4 forms request M3 at the IP address of the validating server 7 to initiate access to the selected stream. The request M3 contains the identifier (ID) of NT 4 and the agreed number of the selected content stream. In response to the request M3, the validating server 7 forms the request M4 for a key phrase (password) for the confirmation of the authority of the subscriber's NT 4 to access content. In response to M4, NT 4 transmits the message M5 containing a personal key phrase. In case of the successful authorization of the subscriber (e.g., the provided key phrase matches a key phrase for the subscriber as stored in a database of the validating server), the validating server 7 generates a message M6 for ACS 5 containing the ID of NT4 and the agreed number of the content stream. M6 permits NT 4 to access the selected content and ACS 5 transmits a message M7 to NT4 containing the IP address of the selected content stream. At the same time, a secure communication channel between NT 4 and the validating server 7 used during the procedure of content stream retransmission is formed. Thus, upon validation of the subscriber, the validating server may provides session keys for a group of the reformatted encrypted content streams from the content provider in response to requests from the network terminal without repeating validation procedures for the subscriber.

The procedure of NT content stream retransmission (section II in FIG. 2) includes the terminal receiving the content stream at its IP address, de-multiplexing the ECM from it, decrypting CW using the session keys received from the validating server 7, descrambling the content data with the used CW, and playing the content on a player. The NT 4 receives the current SK from the validating server 7 in message M9 in response to a request M8 including the IP address for the chosen encrypted content stream through the secure communication channel. In this case, the control of the rights of the content provider 1 includes the fact that retransmission of the stream can be cancelled by both the operator of a computer network 3 by the limitation of access to the IP address of content in CN 3 for a given terminal NT 4 at the subscriber port and at the initiative of the validating server 7 by refusing to provide the session keys SK required by NT 4.

In the illustrated method, the enhancement of content protection is achieved by the CSAS 2 removing the original ECM and EMM messages from the output content stream. Thus, direct use of technologies for unidirectional communication channels (DVB-S, DVB-C) perfected by content pirates is prevented.

The suggested method of adaptation at the CSAS 2 is convenient in that it uses a widespread computer networks technology such as encapsulation of the provider's content stream in the format of the transport stream into packages of user datagram protocol (UDP) for multicast or unicast from designated IP addresses. In addition, there is the possibility to realize a broadcasting mechanism using transmission control protocol (TCP), which is widespread in the Internet, for example, through hypertext transfer protocol (http), real-time protocol (RTP), real-time protocol for media streams (RTSP), and file transfer protocol (FTP). For example, the provider's content stream can be encapsulated in one of the following formats: MPEG1, MPEG2, MPEG4, WM, RA, RV, AVI, OGG, MP3, PCM, WAV, AIFF, and ADPCM.

The realizations of provider content streams may have various technical representations; the most widespread of them is broadcasting through DVB-specifications (DVB-S, DVB-T, DVB-C, DVB-H). It is thus possible to create functional and economically effective CSAS realization by the integration of modules receiving modulated DVB content streams from the content provider through asynchronous series interface (ASI) or synchronous parallel interface (SPI). In certain cases, the CSAS 2 is realized with integrated analog media capture cards. In this realization, the content stream represents analog (video, audio) signals. Also, the provider's content stream can represent already formed IPTV packages in UDP packages for multicast and unicast from designated IP addresses. This gives the simplest conditional access system realization.

Content is often transmitted by providers in the form of files in formats TS, MPEG1, MPEG2, MPEG4, WM, RA, RV, AVI, OGG, MP3, PCM, WAV, AIFF, ADPCM both through a computer network and on hard data carriers (DVD, CD, Flash-card, hard drive). The files transmitted to the content stream adapting server are encrypted using control words and are transmitted to the content stream adapting server in entitlement control messages or in a separate file through the computer network or on removable data storage devices. These formats also permit effective conditional access system realization in accordance with the invention.

In accordance with the invention, the content provider 1 has the opportunity to protect their rights by transmitting not open but already scrambled content. The maximum level of security will be achieved if control words are transmitted separately from files of content data.

The most widespread method of provider's content stream (or control word) scrambling is the common scrambling algorithm (CSA). However, other methods of cryptographic protection of provider content are also suitable for stream adaptation process, for example, encrypting algorithms RC4, AES-128, State Standard (GOST) 28147-89, DES, and/or HC-128. In separate cases, these security operations (data scrambling/encrypting) can be performed at CSAS 2.

The method of the invention permits creating simple and intuitively understandable interfaces for interactions between subscribers and the system through NT 4. For the confirmation of NT authorization to access content, the validating server 7 can generate a hypertext (html) page, where a number of options for the confirmation of conditions for access to content (for example, a list of the numbers of already activated prepayment cards for different channel packages) is given. If the choice of an option has been made by the subscriber earlier, it is possible to select a default variant of the subscription. The subscription can be activated from a portion of such page requesting entry of a PIN code that corresponds to a payment card. The content provider also may be paid directly for the selected content by the subscriber using a prepaid PIN code card issued by the content provider.

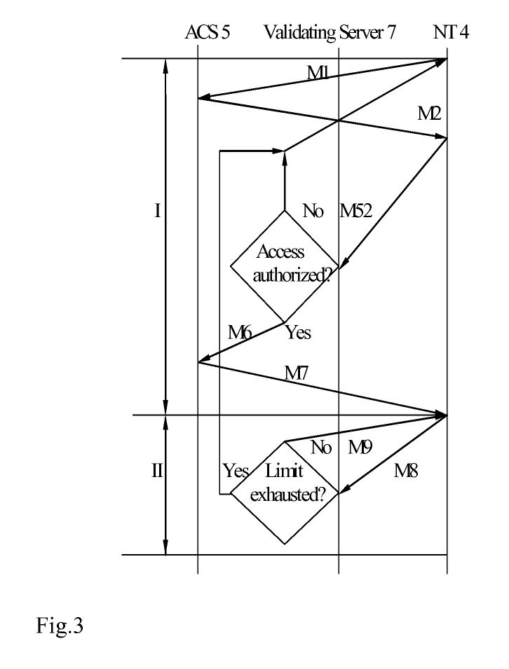

The depth of interaction between the subscriber at NT 4 and ACS 5 in accordance with the method of the invention can be reduced if a simplified procedure for providing access is used as illustrated in FIG. 3. In this embodiment of the method of the invention, when choosing content during the interaction with EPG 6, the subscriber is requested to enter a PIN-code or a key phrase (password), which will be included in a request message coming to the validating server 7. In the embodiment of FIG. 3, the subscriber at NT 4 provides an inquiry M1 of the list of accessible streams of content from the provider. EPG 6 of ACS 5 provides an answer M2 containing the list of accessible streams of content from the content provider 1. NT4 then provides message M52 to the validating server 7. M52 contains the ID of NT4, a key phrase and a conditional number of the chosen stream of content from the content provider 1. If access is not authorized (e.g., the provided key phrase does not match the key phrase stored in the database of the validating server for the subscriber), the validating server 7 so notifies NT4. On the other hand, if access is authorized, message M6 so indicating is provided to the EPG 6. Message M6 contains the ID of the NT4 and the conditional number of the chosen stream of the content provider 1. EPG 6 then provides a message M7 containing the IP address for the chosen stream of content of the content provider 1 to NT 4. NT 4 then sends an inquiry M8 to the validating server 7 about granting the session keys for the chosen content, and the message M9 from the validating server 7 contains the session keys so long as the session keys are not exhausted.

In the method of ACS operation in a computer network in accordance with the invention, it is convenient to use a media access control address (MAC-address) of NT 4, an IP address assigned to the NT 4, a serial number of NT 4, a key phrase (password), a PIN code or their combination as the NT identifier (ID) when checking for authorization to access content. These data are transmitted to CSAS 2 if NT 4 is successfully authorized. Besides that, security can be strengthened by means of the computer network 3. In this case, the validating server 7 forms messages about access rejection for an unauthorized terminal and transmits them to ACS 5. ACS 5 is then configured to deny access to the IP address of the requested content streams in the computer network 3 for a given NT at the subscriber port.

In order to protect interactive dialog between the validating server 7 and NT 4, it is desirable to use technologies and protocols of password (PIN code) transmission including MD5, SHA1, or State Standard (GOST) R 34.11-94 algorithms and/or to use secure connections through SSL/TLS, IPSec, or Point-to-Point (PTP) Protocols. For example, it is convenient to organize interactions between the subscriber and the ACS 5 in the form of html-pages transmitted through http/https protocols.

Session keys formed in the validating server 7 are provided to CSAS 2, where control words (CW) are encrypted before their introduction into ECMs through use of encrypting algorithms such as AES-128, State Standard (GOST) 28147-89, DES, or HC-128. To achieve the required security level, the session keys are dynamically updated within some period of time. Accordingly, it is possible to create flexible security policy, simple in administrating, if session keys are presented as sets of keys becoming effective simultaneously but having different terms of validity (for instance, a set of keys valid, respectively, for 1, 3, 5, or 15 minutes or 1, 3, 5, or 12 hours). Technically, the session keys can be generated or chosen in accordance with preliminary records at the validating server 7, or they can be received from the content provider 1.

In computer network 3, one may use the Internet Group Management Protocol (IGMP) to limit access to the provider's content at the subscriber's port in case of multicast IP addressing. Additionally, one may use the RADIUS protocol described in specifications RFC 2028 and RFC 2059, Simple Network Management Protocol (SNMP), Address Resolution Protocol (ARP) or their combination to organize the subscriber's access to the port of computer network 3.

Control words of the content provider 1 necessary for the operation of the method can be obtained during decrypting of de-multiplexed ECM stream in the official conditional access module (CAM) of the content provider or can be received directly from the server of the content provider 1 through a secure communication channel. A CAM for CW extraction may be included either in the validating server 7 or in the ACS 5, depending on certain conditions of the system construction. In some cases, it is permissible to transmit open control words to NT 4, but a secure communication channel should be used.

The method of the invention also permits special barely visible distortions (watermarks) to be placed in individual packets of the content data stream at CSAS 2 in order to localize an authorized subscriber that is spreading provider content illegally.

To ensure transparent account settling between CN operators and the providers of content streams, the method of the invention also involves the integration with the billing module 8, in which the ACS 5 generates messages to start/end tariffing of NT access to the selected content stream of the content provider 1. In the exemplary embodiment, the validating server 7 also integrates the billing module 8 and generates messages for the billing system of CN operators so as to eliminate the possibility of abuses.

For the authorization and definition of the limits of content access by NT 4 in accordance with the invention, the method may use a database built in the validating server 7 that contains at least one of the following fields: ID subscriber, key phrase (password), PIN code of a payment card, MAC address, network hardware address, IP address of the terminal (NT 4), a counter of remaining time limit, and the expiration date of the PIN code for a given record. To check the authority of a subscriber, it is possible to use at the same time several entries of the database for which he may be authorized.

The method of the invention further provides access to the billing module 8 for the content provider 1. Indeed, it is desirable that the content provider 1 is also the owner of the validating server 7. The billing module 8 of the computer network operator gives reports to the content provider 1 through the validating server 7.

### Detailed Description of the System of FIG. 1

For the realization of the aforementioned method of conditional access, a conditional access system for application in computer network is illustrated in FIG. 1. This system contains at least one content stream adapting server (CSAS) 2 of the content provider 1 that assigns unique addresses of basic Internet Protocol to content streams in the computer network (CN) 3. Access to the IP addresses can be obtained through a set of network terminals (NT) 4 containing content players, descramblers and modules requesting access to content. Access requesting modules are connected through the computer network CN 3 to an access control server (ACS) 5 that controls the access of subscribers to the computer network 3, and the validating server 7 provides session keys (SK) to the NT 4 for protecting control words (CW) of the provider's content. CSAS 2 adapts a protected (scrambled) stream of provider content for retransmission in the CN 3, and during retransmission a stream of content bits is re-encapsulated in a format suitable for transmission with use of the IP address provided by CSAS 2. During retransmission, blocks of scrambled/encrypted data of content flow are not modified. Instead, control words necessary for descrambling/decrypting content data are encrypted with SK transmitted to the CSAS 2 from the validating server 7 and included in ECM messages.

The procedure of providing access to content using the arrangement of FIG. 1 is described above with respect to FIG. 2 and includes the following steps. In the course of interactions with the Electronic Program Guide (EPG) 6 functionally connected to ACS 5, the NT 4 forms a request to initialize access to a selected stream at an IP address of the validating server 7. The request includes the ID of NT 4 and the agreed number of the selected content stream. In response to this message, the validating server 7 generates a request for NT 4 to confirm authorization to access content. The response of NT 4 is a message with a personal key phrase. If the authorization of NT 4 is successful (e.g., the provided key phrase matches a key phrase for the subscriber as stored in a database of the validating server), the validating server 7 forms a message for the ACS 5, containing the ID of NT 4 and the agreed number of the content stream permitting the subscriber to access the selected content. Then ACS 5 sends NT 4 a message containing the IP address of the selected content stream. At the same time, a secure communication channel between NT 4 and the validating server 7 is formed. Through this channel, the validating server 7 sends messages with current SKs to the NT 4. For content stream playback, NT 4 de-multiplexes ECMs from the provider content data received from the CSAS 2 at IP address, decrypts control words using session keys, descrambles content data using the control words, and plays the content data on a media player of NT 4. The retransmission of the stream can be cancelled both by the computer network operator by the limitation of access to the IP address at the subscriber port in CN 3 for a certain terminal and at the initiative of the validating server 7 by its refusal to provide the session keys requested by the terminal.

In the ACS 5 of FIG. 1, it is possible to use both set top boxes (STB) and personal computers with appropriate software installed on them as network terminals. The STBs may thus provide access to the encrypted content streams for a subscriber under control of an operator of the computer network 3. For interaction with the ACS 5 it is suggested to use a module of electronic program guide (EPG) 6, which can be built in the ACS 5 or can be constructed in the form of one or several servers, including validating server 7.

For CW extraction, the system can use one or more conditional access modules of the content provider 1. These modules can be placed at CSAS 2 as well as at the validating server 7.

Those skilled in the art will appreciate that the system and method of the invention are distinctive in that the invention supports several different content providers provided there are several validating server 7 in the system belonging to different content providers.

Moreover, to fulfil the requirement the ACS 5 providing the possibility of transparent accounts for the content provider 1, billing module 8 can be combined with the validating server 7 as well as the ACS 5.

For the data used in NT authorization there is a database built in the validating server 7 that contains at least one of the following fields: ID subscriber, PIN-code, key phrase (password), MAC-address, IP-address of the terminal, a counter of remaining time limit and expiration date of PIN code for a given record.

Those skilled in the art will appreciate that a set of PIN codes may correspond to a set of payment cards. Such payment cards can be presented as material data carriers with records protected by special layers and distributed in the trading network and as PIN code records at the electronic commercial servers. In such an embodiment, it is possible to provide flexibility of tariff plans, which can not be achieved when using conditional access chip cards for a widespread conditional access system. For example, the subscriber can view any channel from a set program package after entering a certain PIN code with a total viewing time of several minutes and the expiration time of the subscription conditions of several months/years.

The system of the invention permits the validating server 7 to be located at the premises of the content provider 1, which allows the content provider 1 to control all subscribers and to avoid manipulations of accounts by computer network operators. On the other hand, if the relationship between the computer network operator and the content provider are trusted, then the validating server 7 and ACS 5 can be integrated so that they have a common IP address. This will result in some simplification of the ACS 5. These and other such modifications are believed to be within the scope of the present invention as identified by the followings claims.

1-60. (canceled)

1. Method of providing conditional access via an access control server of a computer network by a subscriber to encrypted content of a content provider, comprising:
a content stream adapting server receiving streams of encrypted content from the content provider, reformatting said encrypted content streams using session keys from a validating server into a format suitable for transmission by IP addressing, and assigning a unique IP address in said computer network to said reformatted encrypted content streams;
receiving from a subscriber at the validating server a request for an encrypted content stream, said request including an identification of the encrypted content stream selected by the subscriber and an ID of the network terminal of the subscriber; and
upon validation of the subscriber, the validating server providing the subscriber's network terminal with the session keys for the selected encrypted content stream through a secure network channel and authorizing the access control server to provide access to the selected encrypted content stream by the network terminal of the subscriber,
whereby the content provider maintains control over distribution of the selected encrypted content stream through selective validation of subscribers at the validating server.

2. The method of claim 1, wherein reformatting said encrypted content streams comprises encrypting control words used to encrypt said encrypted content streams, said encrypting using said session keys from the validating server and introducing the encrypted control words into a stream of entitlement control messages of said reformatted encrypted content streams without modifying data blocks of encrypted content from said content provider.

3. The method of claim 1, further comprising the validating server validating the subscriber by requesting a personal key phrase from the subscriber's network terminal and receiving the personal key phrase from the subscriber's network terminal for validation against a personal key phrase stored in a database of the validating server.

4. The method of claim 2, wherein the content stream adapting server removes entitlement control messages from encrypted content streams received from the content provider and assigns to a new stream of entitlement control messages an IP address different from an IP address of a corresponding encrypted content stream.

5. The method of claim 1, wherein reformatting the encrypted content streams from the content provider comprises formatting the encrypted content streams into the format of a transport stream for broadcasting UDP packets for multicast or unicast from designated IP addresses.

6. The method of claim 5, wherein said transport stream format includes MPEG1, MPEG2, MPEG4, WM, RA, RV, AVI, OGG, MP3, PCM, WAV, AIFF, or ADPCM.

7. The method of claim 1, wherein the encrypted content streams are transmitted to the content stream adapting server in the form of DVB-signals including DVB-S, DVB-T, DVB-C, or DVB-H, through either ASI or SPI-interfaces, or in the form of analog audio/video signals through the computer network in UDP packets for multicast or unicast from designated IP addresses.

8. The method of claim 1, wherein the encrypted content streams are transmitted to the content stream adapting server in the form of files in formats MPEG1, MPEG2, MPEG4, WM, RA, RV, AVI, OGG, MP3, PCM, WAV, AIFF, or ADPCM.

9. The method of claim 8, wherein the files transmitted to the content stream adapting server are encrypted using control words and are transmitted to the content stream adapting server in entitlement control messages or in a separate file through the computer network or on removable data storage devices.

10. The method of claim 1, wherein content data of the reformatted encrypted content streams are protected using a common scrambling algorithm or one of the following encrypting algorithms RC4, AES-128, GOST 28147-89, DES, or HC-128.

11. The method of claim 1, wherein content data of the reformatted encrypted content streams are scrambled and/or encrypted at the content stream adapting server.

12. The method of claim 1, further comprising the validating server validating the subscriber by generating an html page suggesting a number of options for confirming access conditions, identifying what default conditions are accepted, and/or requesting entry of a PIN code.

13. The method of claim 1, wherein a subscriber provides a PIN code or a key phrase to the access control server during a process of selecting an encrypted content stream, said validating server authorizing the subscriber and providing said session keys to the subscriber's network terminal when the validating server receives a subscriber ID, a MAC address of the network terminal, an IP address assigned to the network terminal, a serial number of said network terminal, said key phrase, and/or said PIN code.

14. The method of claim 1, wherein when the validating server denies validation of the subscriber a message about the denial of access to the encrypted content streams by the network terminal is provided to the access control server and the access control server is configured to deny access to the IP address of the requested encrypted content streams at a subscriber port in the computer network for the subscriber's network terminal.

15. The method of claim 1, wherein the validating server provides said secure network channel by interconnecting with the network terminal using protocols of PIN code transmission in which algorithms MD5, SHA1, GOST R 34.11-94 are applied or by establishing a secure connection through SSL/TLS, IPSec, point-to-point (PTP) protocols, or through http/https protocols.

16. The method of claim 1, wherein reformatting the encrypted content streams comprises encrypting control words before introduction of the control words into entitlement control messages associated with the encrypted content streams, said encrypting of said control words being performed using an encrypting algorithm selected from AES-128, GOST 28147-89, DES, and HC-128.

17. The method of claim 1, wherein said session keys are presented to said network terminal as sets of keys that become effective simultaneously but have different terms of validity.

18. The method of claim 1, wherein session keys are generated or chosen from a database record at the validating server or are transmitted to the validating server from the content provider.

19. The method of claim 2, wherein control words of the content provider are transmitted over a secure communication channel from the content provider to the content stream adapting server, are decrypted at the content stream adapting server or validating server from a stream of entitlement control messages from the content provider, or are transmitted to the network terminal in open form but through a secure communication channel.

20. The method of claim 1, further comprising placing watermarks into individual packets of the reformatted encrypted content streams of the at the content stream adapting server.

21. The method of claim 1, further comprising the access control server generating messages to a billing system of the computer network to start/end tariffing access of the network terminal to the selected encrypted content stream.

22. The method of claim 1, wherein upon validation of the subscriber, the validating server provides session keys for a group of the reformatted encrypted content streams from the content provider in response to requests from the network terminal without repeating validation procedures for the subscriber.

23. A conditional access system that provides conditional access by a subscriber's network terminal over a computer network to encrypted content of a content provider, comprising:
a content stream adapting server that receives streams of encrypted content from the content provider, reformats said encrypted content streams using session keys into a format suitable for transmission by IP addressing, and assigns a unique IP address in said computer network to said reformatted encrypted content streams;
an access control server that provides access to the encrypted content streams under control of an operator of said computer network; and
a validating server that provides said session keys to said content stream adapting server, receives from a subscriber a request for an encrypted content stream, said request including an identification of the encrypted content stream selected by the subscriber and an ID of the network terminal of the subscriber, validates the subscriber for access to the requested encrypted content stream and, upon validation of the subscriber, provides the subscriber's network terminal with the session keys for the selected encrypted content stream through a secure network channel and authorizes the access control server to provide access to the selected encrypted content stream by the network terminal of the subscriber,
whereby the content provider maintains control over distribution of the selected encrypted content stream through selective validation of subscribers at the validating server.

24. The system of claim 23, wherein said content stream adapting server reformats said encrypted content streams using encrypting control words for encrypting said encrypted content streams with said session keys from the validating server and introduces the encrypted control words into a stream of entitlement control messages of said reformatted encrypted content streams without modifying data blocks of encrypted content from said content provider.

25. The system of claim 23, wherein the validating server comprises a database that stores personal key phrases of subscribers, said validating server validating the subscriber by requesting a personal key phrase from the subscriber's network terminal and receiving the personal key phrase from the subscriber's network terminal for validation against a personal key phrase for the subscriber stored in said database.

26. The system of claim 23, wherein said access control server comprises a set-top box with software installed thereon for providing access to the encrypted content streams under control of an operator of said computer network.

27. The system of claim 23, wherein said access control server or said validating server comprises an electronic program guide module.

28. The system of claim 23, wherein said content stream adapting server and/or said validating server comprises a conditional access module of the content provider.

29. The system of claim 23, further different content providers have different validating servers.

30. The system of claim 23, wherein said access control server or said validating server further comprises a billing module that starts/ends tariffing access of the network terminal to the selected encrypted content stream.

31. The system of claim 25, wherein the database contains at least one of the following fields for a given record: subscriber ID, subscriber key phrase, PIN code of a payment card, media access control address of the subscriber's network terminal, network hardware address, IP address of the network terminal, a counter of a remaining time limit, and an expiration date of a PIN code.

32. The system of claim 23, wherein the validating server and the access control server have a common IP address.
